(19) United States
(12) Patent Application Publication
(10) Pub. No.: US 2024/0018715 A1
(43) Pub. Date: Jan. 18, 2024

(54) BIOBASED MATERIAL AND METHOD FOR PREPARING SAME

(71) Applicants: Centre National de la Recherche Scientifique (CNRS), Paris (FR); Universite Jean Monnet Saint Etienne, Saint Etienne (FR); La Tannerie Vegetale, Meyzieu (FR); Université Claude Bernard Lyon 1, Villeurbanne (FR)

(72) Inventors: Fanny DELEAGE, Meyzieu (FR); Yvan CHALAMET, Monistrol Sur Loire (FR)

(73) Assignees: Centre National de la Recherche Scientifique (CNRS), Paris (FR); Universite Jean Monnet Saint Etienne, Saint Etienne (FR); La Tannerie Vegetale, Meyzieu (FR); Université Claude Bernard Lyon 1, Villeurbanne (FR)

(21) Appl. No.: 18/032,044

(22) PCT Filed: Oct. 15, 2021
(86) PCT No.: PCT/EP2021/078687

§ 371 Date: Apr. 14, 2023

(30) Foreign Application Priority Data
Oct. 15, 2020 (EP) 20306211.2

(51) Int. Cl. D06N 3/00; C14C 3/26

(52) U.S. Cl. CPC D06N 3/0061; C14C 3/26

(57) ABSTRACT

The present disclosure relates to a method for the preparation, from a mixture comprising (i) plant proteins, (ii) one or more plant tanning agents, (iii) one or more plasticizers, of a biobased material that may resemble animal leather.

### FIELD OF THE INVENTION

The present invention relates to a method for preparing, from plant proteins, a biobased material that may resemble animal leather.

### TECHNOLOGICAL BACKGROUND

The leather industries are frequently criticized for their environmental impact. The high consumption of water, the large number of chemical inputs and the potential disposal of chemical and organic wastes into the air and water, during the tanning process, contributes to the negative image of this industry. Many consumers worried about these environmental issues are turning away from animal leather.

In response to these ecological concerns and to meet a new demand, new materials resembling animal leather have emerged and continue to emerge. The main alternatives proposed are fully synthetic petroleum-based materials (e.g., polyvinyl chloride) or made from a natural or synthetic fiber base coated with a plastic material, such as polyurethane. There are other alternatives, more confidential and more expensive, such as pineapple leather, made from the pineapple leaves, eucalyptus leather, made from eucalyptus leaves, or mushroom leather. Very generally, polyurethane is mixed with these natural elements. It has also been proposed to prepare alternatives to animal leather from plant proteins. Thus, JPH04153378 proposes a method for preparing an alternative material comprising a step of extruding plant proteins (soy proteins) followed by a step of chrome or plant-based tanning of the resulting material.

However, some of these alternatives do not appear to be entirely satisfactory from an ecological point of view. Polyurethane-based materials are derived from petrochemicals and are difficult to integrate into an ecologically responsible preparation method. In addition, the life cycle of materials is not always considered as a whole. Recycling of some of these alternatives, especially those comprising fibers associated with polyurethane, can be difficult. Finally, these alternatives do not allow obtaining a material with a thermoplastic character.

Thus, a need remains for a biobased, recyclable material that can be used for a wide variety of applications in various technical fields. Advantageously, the proposed material can represent a preferred alternative to animal leather. Moreover, the preparation method of the material will be fast, economical and environmentally friendly.

Biobased materials have been proposed, e.g., U.S. Pat. No. 69,02,783, EP0976790, Sun et al, Food Hydrocolloids, vol. 21, p.1005-1013. These materials are obtained by cross-linking biopolymers or plant proteins by means of a cross-linking agent, of the aldehyde or polyaldehyde type. The methods do not use plant tanning agents. The chemical bonds formed are then covalent and do not allow obtaining a recyclable and thermoplastic-like material.

### BRIEF DESCRIPTION OF THE INVENTION

The present invention relates to a method for preparing, from plant proteins, semi-finished products comprising the following steps:
(a) Fluidization and kneading of a mixture comprising:
   (i) plant proteins;
   (ii) one or more plant tanning agents;
   (iii) one or more plasticizers;
(b) Compressing the fluidized and kneaded mixture in order to produce the semi-finished products,

as well as on the semi-finished products obtainable by such a method, and their uses for the preparation of articles (commercial articles).

The present invention also relates to a method for preparing an article from a semi-finished product as herein described, comprising a step of shaping the semi-finished product under press, by extrusion calendaring, extrusion swelling, extrusion spinning, injection, 3D printing or molding. The present invention also relates to articles obtained by such a method. Other aspects of the invention are as described below and in the claims.

### FIGURE

FIG. 1 shows photographs of samples T1 to T4 obtained by extrusion.

### DETAILED DESCRIPTION OF THE INVENTION

The inventors have developed a method for preparing semi-finished products which, in certain forms (sheets, films, plates), may resemble animal leather, or which allows the preparation, from plant proteins, of a material which may resemble animal leather.

Thus, the present invention relates to a method for preparing, from plant proteins, semi-finished products comprising the following steps:
(a) Fluidization and kneading of a mixture comprising:
   (i) plant proteins;
   (ii) one or more plant tanning agents;
   (iii) one or more plasticizers;
(b) Compressing the fluidized and kneaded mixture in order to produce the semi-finished products.

The present invention also relates to semi-finished products obtainable by the method of the present invention.

The term “semi-finished product” as used in this description refers to products that will serve as a basis for the preparation of a wide variety of articles.

The term “semi-finished product” includes, but is not limited to, sheets, films, plates, wires, technical profiles, rods, tubes, solid shapes and pellets.

Examples of articles that can be prepared from the semi-finished products of the present invention include, but are not limited to, packaging, molded objects that can be intended for food contact (cups, food containers, cutlery . . . ), molded objects for domestic, textile or decorative use (pots, boxes, protective shells, buttons, tokens, handles, armrests, soles . . . ), textile articles and accessories, leather goods articles and accessories, sports articles, films or nets for agriculture or gardening, finishing films for flexible materials and foams. The semi-finished products can also be used to prepare aqueous solutions and suspensions for surface coating.

The term “technical profile” as used in the present description refers to a material to which a particular shape has been given.

The method of the present invention as well as the semi-finished products obtainable by this method are as described below.

### Components of the Mixture for Preparing the Semi-Finished Products

The semi-finished products of the present invention are obtained after fluidizing, kneading and compressing a mixture comprising (i) plant proteins, (ii) one or more plasticizers and (iii) one or more plant tanning agents. The mixture may further comprise optional organic or inorganic additives/components (e.g., filler, dye, pigment, viscosity modifier, pH modifier, preservative, hydrophobic agent, surfactant, ionicity modifier, UV stabilizers).

The mixture of plant proteins, one or more plant tanning agents and one or more plasticizers leads to the preparation of a thermoplastic-type material. Such a character thus offers the possibility of very varied shaping, adapted to the use for which the material is intended. The addition of one or more plant tanning agents, directly to the mixture comprising the plant proteins and the plasticizer(s), unexpectedly allows preparing in fine a material resembling animal leather and presenting an increased flexibility and a good water resistance. Moreover, such a material has the advantage of being recyclable.

### Proteins

The proteins useful in the context of the present invention are plant proteins, e.g., proteins from plants or algae.

The mixture typically comprises from 15 to 70% by mass, preferably from 20 to 60% by mass, based on the total mass of the mixture, of plant proteins.

Preferably, the mixture does not include animal proteins (mammals, fish, birds, reptiles and amphibians).

The plant proteins useful in the context of the present invention are preferably selected from the group consisting of cereal proteins (e.g. wheat, buckwheat, barley, rye, corn, oats, spelt, quinoa, amaranth, chia, millets, rice), legume proteins (e.g. beans, peas, broad beans, lupin, lentils, carob, licorice, alfalfa, clover, fenugreek), oilseed proteins (e.g. soy, rapeseed, linseed, hemp, sunflower, castor, palm, oak acorns, peanuts, sesame, walnuts, almonds, cotton, pumpkin seeds, grape seeds, olives, coconuts, hazelnuts), macro-algae proteins (Phaeophyta (brown algae), Chlorophyta and Charophyta (green algae), Rhodophyta (red algae)), microalgae proteins (Bacillariophyta (diatoms), Chlorophyta (green algae), Chrysophyta (golden algae), and Cyanophyta (blue-green algae) (e.g. Arthrospira platensis (Spirulina), Chlorella vulgaris (Chlorella)) and mixtures thereof. Wheat proteins, in particular wheat gluten, broad bean and chlorella proteins are particularly useful in the context of the present invention.

The mixture typically comprises from 20 to 85% by mass, preferably from 15 to 70% by mass, or from 20 to 60% by mass, or from 35 to 75% by mass, based on the total mass of the mixture, of plant proteins. The plant proteins are generally added to the mixture in the form of a plant protein formulation, for example in the form of oil cakes (e.g., rapeseed, linseed, hemp, sunflower cake) or concentrates or isolates (e.g., pea concentrate, broad bean concentrate) or protein-concentrated flours. When the plant proteins are wheat gluten, various qualities of gluten can be used.

Plant proteins or plant protein formulations are typically used in solid form, for example in powder form.

### Plasticizers

The plasticizers used in the present invention act as plasticizing and/or denaturing agents. They make it possible to reduce the viscosity of the mixture, thus facilitating its processing. They also make it possible to increase the flexibility of the material obtained by the method, in particular the flexibility of the sheets or films formed or which can be formed after shaping the semi-finished products.

Plasticizers useful in the context of the present invention are preferably selected from the group consisting of water, crude glycerol, refined glycerol, glycerol derivatives (e.g. glyceryl mono, di- and tri-acetate, diglycerol, polyglycerol, glycerol esters, polyglycerol esters, glycerol carbonate), alcohols, polyols (e.g. propanediol, butanediol, pentanediol, xylitol, erythritol, arabitol, isosorbide, sorbitol, mannitol, maltitol, polyethylene glycol, phenol), saccharides and oligosaccharides, lignans, saturated or unsaturated carboxylic acids, preferably with 2 to 10 carbon atoms, and their salts (e.g. acetic acid, proprionic acid, lactic acid, isobutyric acid, pentanoic acid, haxanoic acid, gluconic acid, sorbic acid, caprylic acid, benzoic acid, gallic acid, hydroxybenzoic acid, salicylic acid, caffeic acid, cinnamic acid, hydroxycinnamic acid, ascorbic acid, succinic acid, tartaric acid, capric acid, or their constitutive isomers or their salts), coumarins, sulfonic acids, amino acids (e.g. proline, leucine, isoleucine, lysine, cysteine), urea, ionic liquids (e.g. ammonium salts), eutectic solvents (e.g. choline/glycerol) and their mixtures. In some preferred embodiments, the plasticizer is selected from glycerol, urea, water, propanediol, potassium sorbate, and mixtures thereof, preferably from glycerol, urea, water, and mixtures thereof. In some embodiments, the plasticizer is a mixture comprising glycerol and a plasticizer other than glycerol. In some embodiments, the plasticizer is a mixture comprising water and a plasticizer other than water. Thus, in these embodiments, the plasticizer may be an aqueous solution of a plasticizer other than water.

The mixture (to be fluidized and kneaded) typically comprises from 15 to 85% by mass, preferably from 20 to 70% or from 20 to 60% by mass or from 35 to 55% by mass, based on the total mass of the mixture, of a plasticizer. Since the plasticizer may be used alone or in a mixture, it is understood that the mixture typically comprises from 15 to 85% by mass or from 20 to 70% by mass or from 20 to 60% by mass or from 35 to 50% by mass, based on the total mass of the mixture, of a plasticizer or a mixture of plasticizers.

The plasticizers can be used in solid or liquid form.

In some embodiments, the mixture does not include any added water (the only water present is provided by the mixture components).

Tanning agents

Plant tanning agents (or plant tannins) useful in the context of the present invention include polyphenolic tanning agents and mixtures thereof.

Polyphenolic tanning agents typically comprise from 2 to 10 phenolic units which may be bound to sugars or terpenes.

Plant tanning agents can be natural (e.g., plant extracts) or obtained by chemical synthesis. Preferably, the plant tanning agents are natural agents.

The mixture typically comprises from 0.01 to 20% by mass, preferably from 2 to 15% or from 2 to 8% by mass, based on the total mass of the mixture, of one or more tanning agents selected from polyphenolic tanning agents.

In some embodiments, inorganic tannins for reversible tanning, such as potassium alum, may be added to the plant tanning agent(s).

In some embodiments, the mixture does not include organic tanning agents selected from aldehydes (e.g., polyaldehydes, dialdehydes, glutaraldehyde, formaldehydes, quinones, phospholipids, polyphosphates) and mixtures thereof. Such agents create an irreversible cross-linking of the material.

In some embodiments, the mixture does not include inorganic (metallic or mineral) tannins selected from chromium salt, aluminum salt, zirconyl salt, iron and/or titanium salt, sulfur, or mixtures thereof. Such agents create an irreversible cross-linking of the material.

Polyphenolic tanning agents can be selected from synthetic agents (e.g., naphthalene polymers, phenol polymers, bisphenol polymers and combinations thereof).

Plant tannins (plant tanning agents) are substances of the polyphenol family that have the ability to bind and precipitate proteins. Based on their structural characteristics, tannins can be classified into four major groups: gallotannins, ellagitannins, complex tannins, and flavonoids, including condensed tannins.

Gallotanins are tannins formed by galloyl units or their derivatives meta-depsidic units linked to various polyol-, flavanol- or triterpenoid units. Ellagitanins are tannins formed by at least two galloyl units coupled together by C-C bonding and not comprising a glycosidic bond with catechin units. Complex tannins are the ones where a gallotanin or ellagitanin unit is linked to a catechin unit by a glycosidic bond. Condensed tannins are proanthocyanidols formed by the bond between the C-4 of a catechin unit and the C-8 or C-6 of another catechin unit. They typically comprise from 2 to 8 catechin units and have a molecular weight ranging from 300 to 100 000 g.mol⁻¹. Catechin monomers are part of the broader flavonoid family, along with isoflavonoids, flavones, flavonols, flavanonols, flavanones, aurones, chalcones, dihydrochalcones, anthocyanidols, flavanediols, and flavan-3-ols (catechins), anthocyanidins, and flavanic compounds. Plant tannins can be extracted from wood, bark, leaves, roots, galls, pits, skins and seeds of a wide variety of plant species. Plant tannins useful in the context of the present invention are preferably condensed (flavonoids) or hydrolyzable tannins.

Some of the plant tannins particularly useful in the context of the present invention include those derived from plant species selected from the group consisting of chestnut, mimosa, pine, spruce, willow, birch, mangrove, quebracho, oak, cachou, heather, canaigre, sumac, gambier, myrobalan, tara, acacia, hawthorn, pecan, grape, sorghum, cranberry, cocoa, coffee, buckthorn, reseda and mixtures thereof.

The mixture typically comprises from 0.01 to 20% by mass, preferably from 2 to 15% by mass or from 2 to 8% by mass, based on the total mass of the mixture, of one or more plant tannins.

Plant tannins are typically used in solid form, for example in powder form.

### Optional Additives

The mixture may further comprise functional additives.

By adding a filler, it is possible to bring a structural reinforcement to the formed material (reinforcing filler) and thus improve its resistance and decrease its deformation. It can also, if it is hygroscopic, help to regulate the water content of the material.

The mixture can thus contain from 0.05 to 20% by mass, preferably from 0.1 to 15% by mass, of a reinforcing filler relative to the total mass of the mixture.

Preferably, the filler is a cellulose derivative (e.g., cellulosic fiber, microcrystalline cellulose), an organic filler (e.g., cross-linked starch, wool, lignins, lignosulfonates), a mineral filler (e.g., clay, glass fiber, rock fiber, calcium carbonate, zinc oxide, silica), a synthetic filler (e.g., biobased polymers, petroleum-derived polymers, recycled thermoplastics and thermosets), or mixtures thereof. Biomass derivatives such as wood, flax, hemp, wheat, apple and other agri-food co-products can be sources of cellulose and lignin derivatives.

The mixture may further comprise a coloring agent or pigment. The mixture may thus contain from 0.01 to 30% by mass, preferably from 0.05 to 10% by mass, of a coloring agent or pigment based on the total mass of the mixture. Preferably, the coloring agent is a natural colorant (e.g., indigo, flavone, flavonol, flavonoid, polyphenols).

Preferably, the coloring pigment is titanium dioxide.

The mixture may also include an odorant (e.g., perfume, aromatic plant extract, essential oil).

The mixture may further comprise agents to control browning reactions, such as the Maillard reaction (e.g., ferulic acid).

The mixture may also include a viscosity modifier. The viscosity modifier can be used to promote texturization of the material. The mixture may thus contain from 0.01 to 30% by mass, preferably from 0.05 to 10% by mass, of a viscosity modifier relative to the total mass of the mixture. Preferably, the viscosity modifier is selected from flours (e.g., corn flour, cereal flour, proteinaceous flour, oilseed flour), native and modified polysaccharides (e.g., starch, hemicellulose, alginates, carrageenans, acacia gum, guar gum, mucilage, chitin and its derivatives, hydroxylated, methylated, carboxymethylated and/or ethylated cellulose) and mixtures thereof. A variety of starches can be used such as corn starch, wheat starch, potato starch and mixtures thereof. The starches can be native or modified for example by gelatinization or chemical treatment (e.g., oxidized, acetylated, carboxymethylated, hydroxyethylated, cross-linked starches).

The mixture may further comprise a preservative which may contain from 0.01 to 3% by mass, preferably from 0.1 to 1% by mass, of a preservative based on the total mass of the mixture. Preferably, the preservative is selected from organic substances (e.g., propionic acid, sorbic acid and its calcium and potassium salts, benzoic acid, fumaric acid, dimethyl dicarbonate) and mineral substances (e.g., sulfites, sulfur dioxide, nitrates, nitrites, sodium chloride) and mixtures thereof.

The mixture may further comprise an agent that improves the processability and flexibility of the material. Examples of such agents include terpene derivatives, for example terpenes from oranges or wood (e.g., pine rosin).

The mixture may also include a hydrophobic agent. The hydrophobic agent can improve the look and feel of the material, reduce the moisture permeability of the material, decrease its absorption, but also reduce its sensitivity to water. Thus, the mixture may contain from 0.01 to 5% by mass, preferably from 0.05 to 2% by mass, of a hydrophobic agent based on the total mass of the mixture. Preferably, the hydrophobic agent is selected from the group consisting of oils (e.g., grape seed oil, rapeseed oil, sunflower oil, linseed oil, hemp oil, castor oil, cottonseed oil, olive oil, avocado oil, tall oil, peanut oil containing fatty acids which can be modified), fats, native and modified lecithins, waxes (e.g., beeswax, carnauba wax) and mixtures thereof.

The mixture may further comprise a pH modifier. The pH modifier may allow the solubility of the plant proteins and other compounds used to be modified. Thus, the mixture may contain from 0.01 to 5% by mass, preferably from 0.05 to 2% by mass, of a pH modifier based on the total mass of the mixture. Preferably, the pH modifier is selected from acetic acid, citric acid, tartaric acid, formic acid, lactic acid, slaked lime, soda ash, hydrochloric acid and mixtures thereof.

The mixture may further include a salt to change the ionicity of the plant proteins.

### Method for Preparing Semi-Finished Products

The fluidization of the mixture comprising (i) proteins, preferably plant proteins, (ii) one or more plasticizers, (iii) one or more tanning agents, preferably plant tannins, and (iv) optionally additives as described above, is typically obtained by heating the mixture to a temperature ranging from 60 to 250° C., preferably from 90 to 180° C. or even from 140 to 160° C. This temperature is typically chosen so as to fluidize the mixture without degrading its components. The processing temperature depends on the formulation of the mixture, typically on the content of plasticizers. Thus, the heating temperature is typically lower than the thermal decomposition temperature of the mixture components. In some embodiments, the temperature is about 150° C. Mechanical kneading is used to homogenize the mixture. Kneading is typically performed at the fluidization temperature.

The mixture is typically processed in an extruder equipped with an extrusion head, referred to as a “die”. Thus, the mixture is fluidized and kneaded in an extruder and then compressed in a die to form semi-finished products.

These semi-finished products are made of a material with a thermoplastic character. Moreover, this material is biodegradable.

Thus, in other words, the present invention relates to a method for preparing semi-finished products from proteins, preferably plant proteins, comprising extruding and compressing a mixture comprising (i) proteins, preferably plant proteins; (ii) one or more tanning agents, preferably plant tannins; (iii) one or more plasticizers; and (iv) optionally additives. The compression is carried out using a die.

It is understood that the choice of the die at the exit of the extruder defines the nature and the geometry of the semi-finished products. The die can be used to obtain sheets, films, plates, wires, rods, tubes, solid shapes and technical profiles.

The extruder may be a conventional screw extruder commonly used for the extrusion of thermoplastic material. The extruder may be a single or multiple screw extruder rotating within a barrel. Preferably, the extruder is a twin-screw extruder, typically a co-rotating twin-screw extruder. The L/D ratio of the extruder (L=screw length; D=screw diameter) typically ranges from 10 to 100, preferably from 20 to 60. The rotational speed of the screw or screws typically ranges from 10 to 1500 rpm, preferably 200 to 1000 rpm.

The extruder includes at least one conveying zone and at least one kneading zone. The extruder may comprise alternating conveying zones and kneading zones. The conveying zone(s) allows the solids and liquids to be mixed, progressively compressed and heated. The kneading zone(s) allow for more intense mixing of the components of the mixture, particularly by increasing the residence time. The extruder can also include a degassing zone, either in the open air or with suction.

The temperature within each zone of the extruder can vary. Typically, the extruder includes at least one conveying zone with a temperature of up to 250° C. and at least one kneading zone with a temperature of up to 200° C. The extruder can also include a heating zone to gradually increase the temperature of the conveying zone to that of the kneading zone. At the die inlet, the temperature of the mixture typically varies from 90 to 180° C. and can be cooled in the die to a temperature typically ranging from 70 to 150° C.

The screw profile can be chosen according to the constraints that the skilled in the art desires to apply to the mixture.

The residence/dwell time of the mixture in the extruder typically ranges from 20 s to 15 min, preferably from 2 to 6 minutes.

The components of the mixture are introduced into the extruder in liquid or solid form through feed hoppers. The components can be introduced through a main feed port and possibly through secondary ports, using metering devices for solids or pumps for liquids. For example, proteins, preferably plant proteins, are typically introduced in solid form, plasticizers in liquid form and tanning agents in solid form.

The components are typically introduced into the extruder at a temperature of 20-90° C.

In other embodiments, the mixture components may be mixed using a co-kneader.

The resulting semi-finished products are then cooled to their final shape, either in the ambient air, in a liquid bath such as water or fat, or on cooled cylinders. Typically, a cooling device is placed at the die exit. Thus, the method of the present invention may include a step for cooling the prepared semi-finished products.

The method may also include a step of drying the prepared semi-finished products.

When the mixture is compressed into profiles, tubes or rods, the profiles, tubes or rods can then be cut into pellets.

The cutting may be performed before or after cooling. Thus, the method of the present invention may include a granulation step. The granulation operation may be performed under conventional conditions well known to the skilled in the art.

The pellets obtained can then be shaped according to techniques well known in the field of plastics processing, for example under press, by extrusion calendering, extrusion swelling, extrusion spinning, injection, 3D printing or molding. Thus, the present invention also relates to a method for preparing an article from pellets comprising a step of shaping the article under press, by extrusion calendering, extrusion swelling, extrusion spinning, injection, 3D printing or molding.

The pellets can thus be used to prepare a wide variety of commercial articles, such as sheets, films, packaging, molded objects that may be intended for contact with food (cups, food containers, cutlery, etc.), molded objects for domestic, textile or decorative use (jars, boxes, shells, tokens, handles, etc.), textile articles, leather goods, sports articles, films or nets for agriculture or gardening, finishing films for flexible materials, foams.

When the mixture is compressed into sheets (e.g., using a flat die) or when the pellets are used to form sheets, these sheets may be further processed. For example, the sheets can be calendered. Calendering can smooth the surface of the sheet, reduce its thickness, or imprint a texture on the surface of the sheet, such as a leather grain. The printing of a leather grain can make the obtained material look or feel more like animal leather.

In particular, the sheets can be used as a leather substitute for the manufacture of objects typically made from animal leather or incorporating animal leather parts.

The formed material can also be used as a textile coating base or be used in a multilayer with another material.

Thus, the semi-finished products described in the present application can be used to prepare a wide variety of articles, such as sheets, films, packaging, objects that can be intended for food contact (cup, food container, cutlery . . . ), molded objects for domestic, textile or decorative use (pots, boxes, protective shells, buttons, tokens, handles . . . ), textile articles and accessories, leather goods articles and accessories, sports articles, films or nets for agriculture or gardening, finishing films for flexible materials and foams.

The present invention thus also relates to a method of preparing an article from a semi-finished product as described herein comprising shaping the semi-finished product. The shaping of the semi-finished product is typically performed under press, by extrusion calendering, extrusion swelling, extrusion spinning, injection, 3D printing or molding.

The present invention thus also relates to an article prepared from a semi-finished product as described in the present description. The article may be an injection molded article.

Advantageously, the method of the present invention avoids the tanning steps typically implemented in the preparation of leather substitutes. These tanning steps consume a lot of water. Therefore, from an economic point of view, the method of the present invention turns out to be very competitive since it allows saving the costs related to this high-water consumption and to the treatment of the tanning water.

Moreover, the fact of introducing the tanning agents, preferably plant tannins, directly into the mixture intended to be compressed allows the preparation of a material to have great flexibility. In particular, the material obtained by the method of the present invention has a greater flexibility than the material obtained by a method comprising a separate tanning step. The material obtained is flexible, non-brittle and strong.

Furthermore, the material obtained by the method of the present invention has good frictional resistance. It is also waterproof and has good water resistance.

The following examples are given for illustrative purposes. They should in no way be considered as limiting the present invention.

### EXAMPLES

### Commercial References

Gluten: Manito (Eurogerm) Wheat protein (ref FZG309461); Vital wheat gluten (Roquette Frères);
White Chlorella: White Chlorella powder (ref 910287) (Greentech SA);
Broad bean proteins: Fava bean protein 60 SMP (Univar);
Glycerol: Lucemill ltd., Vegetable Glycerine (VG) EP/BP Pharmaceutical Grade;
Extracts of catechu, myrobalan, buckthorn, reseda, tannins of white grape, chestnut tree and Occitan chestnut tree, ferrous sulfate: Green'ing SARL;
Gambier: Pure Catechu extract (SCRD);
Kaolin: PoleStar 200R (Imerys);
Corn bran: Sofabran 184-80 Corn fiber (Limagrain Ingredients).
   1. Preparation of Samples according to the Invention

The samples are prepared in a Thermo Scientific™ brand Eurolab16 extruder, 16 mm in diameter and 640 mm in length, equipped with a flat film die having an adjustable center distance of thickness between 100 μm and 1 mm. The extruder has two intake zones, at least one conveying zone with compression, at least one kneading zone and a die zone. The rotation speed of the twin-screws is 500 rpm and the temperatures of the different zones are between 40 and 160° C.

Proteins, tannins and additives in solid form were introduced in the first intake zone.

The plasticizers and liquid additives were introduced in the second intake zone.

The screw profile is as follows: 22 mm kneading screw and 128 mm direct pitch screw.

Samples EI1 through EI4 were prepared by extrusion of the following mixtures (percentages are by mass to total mixture mass):

| | EI1¹⁾ | EI2²) | EI3¹⁾ | EI4³⁾ |
|---|---|---|---|---|
| Plant Protein (%) | Gluten (53) | Gluten (53) | Gluten (35) | Gluten (44) |
| Plant Tannin (%) | Catechu (5) | Catechu (5) | Catechu (4) | Chestnut (4.5) |
| Plasticizer (%) | Glycerol (41.5) | Glycerol (42) | Glycerol (47) | Glycerol (51) |
| pH Modifier (%) | Slaked | — | — | Slaked |
| | lime (0.5) | | | lime (0.5) |
| Filler (%) | — | — | Kaolin (12) | — |
| Viscosity | — | — | Corn | — |
| Modifier (%) | | | flour (1) | |
| Preservative (%) | — | — | Sodium | — |
| | | | chloride (0.5) | |
| | | | Potassium | |
| | | | sorbate (0.5) | |

¹⁾Extrusion: 500 rpm; 150° C.; 10 bar, 3.8 N · m; 1080 g/h;
²⁾Extrusion: 500 rpm; 150° C.; 5 bar, 4 N · m; 830 g/h;
³⁾Extrusion: 500 rpm; 170° C.; 7 bar, 4.8 N · m; 780 g/h.

The mixtures presented above have produced cohesive materials that can be pressed and/or molded.

The resulting samples are flexible and just as mechanically strong as leather. Moreover, they have a fixed chemical structure that protects them from mold.

The samples turned out to have a good resistance to water. Thus, after one night in water at 65° C., the appearance of the samples was little changed as a very slight swelling could be observed. The samples turned out to have a very slightly softer structure than before immersion and to have a good mechanical resistance, in particular a tear resistance very close to their mechanical resistance before immersion.

The table below shows the characteristics of the EI4 sample. The tests were performed in accordance with the methods cited in the 3rd column of the table.

Characterizations of the sample EI4

| | | | | |
|---|---|---|---|---|
| Thickness | | ISO 2589 | mm | 1.4-1.5 |
| Tearing (longitudinal notch) | Peeling | ISO 3377-1 | N/mm | 5.9 |
| | at 90° 50 | | | |
| | mm/min | | | |
| Tensile failure | | ISO 3376 | N/mm² | 3.2 |
| Breakage | | | % | 123 |
| Elongation at break | | | | |
| Frictional resistance (Veslic) | 250 cycles | NF EN ISO | ./5 | ≥3 |
| (total mass 1.0 kg, 10% extension) | 150 cycles | 11640 | Grey Scale | ≥¾ |
| Dry | 150 cycles | | | ≥¾ |
| Water-based | | | | |
| Sweat | | | | |
| Impermeability to water droplets | 3 min, | Inspired by | Visual | No visible |
| Time of droplet deposit | 30 min | NF EN ISO | | trace (halo, |
| | and 3 h | 15700 | | blister) after |
| | | | | drying or |
| | | | | complete |
| | | | | absorption |
| Strength of the grain to the ball | | ISO 3379 | Mm | >13 |
| to cracking | | | | |
| Flexural Strength Fleaxometer | | ISO 5402-1 | Visual | Failure at more |
| | | | | than 1000 cycles |

The measured characteristics of the sample EI4 show that it meets several criteria of the leather specifications (water resistance—impermeability to water droplets—, frictional resistance and strength of the grain to the ball). If the results of the breakage tests are good, it can be noted that the sample EI4 has a lower elastic modulus and a higher elongation at break than the leather. These differences can be explained by the absence of reinforcing filler.

### 2. Preparation of Comparative Samples—No Tanning Agent

The samples are prepared in a Eurolabl6 extruder equipped with a flat film die as described above.

Samples EC1 to EC4 were prepared by extrusion of the following mixtures (percentages are by mass to total mixture mass):

| | EC1¹⁾ | EC2²⁾ | EC3³⁾ | EC4⁴⁾ |
|---|---|---|---|---|
| Plant Protein (%) | Gluten (56) | Gluten (56) | Gluten (56) | Gluten (35) |
| Plasticizer (%) | Glycerol | Glycerol | Glycerol | Glycerol (11) |
| | (43.6) | (43.6) | (43.6) | Water (43) |
| PH modifier (%) | Slaked | Slaked | Slaked | — |
| | lime (0.4) | lime (0.4) | lime (0.4) | |
| Filler (%) | — | — | — | Kaolin (10) |
| Preservative (%) | — | — | — | Potassium |
| | | | | Sorbate (0.5%) |
| | | | | Sodium |
| | | | | Chloride (0.5%) |

¹⁾Extrusion: 500 rpm, 160° C., 12 bar, 4.2 N · m
²⁾Extrusion: 500 rpm, 150° C., 12 bar, 4.2 N · m
³⁾Extrusion: 500 rpm, 170° C., 7 bar, 3.8 N · m
⁴⁾Extrusion: 400 rpm, 200° C. with cooling at 50° C., 11 bar, 2.4 N · m

The comparative samples EC1 to EC4 turned out to be very sensitive to water. Thus, after one night in water at 65° C., the appearance of the samples changed.

The samples swelled and had a very soft structure. Sample EC3 became unstructured. Moreover, after one night in water at 65° C., their mechanical resistance is lower (it becomes extremely easy to tear them).

### 3. Preparation of Comparative Samples—Extrusion Followed By Tanning

Sample EC4 was extruded without a tanning agent and with a high concentration of water, as described in the previous table, to allow for significant macroscopic texturing.

Sample EC4, prepared as described above, was then processed under conditions approximating those described in JPH04153378. JPH04153378 provides a method for preparing a material comprising a step of extruding plant protein (soy protein) followed by a step of plant or chromium tanning the resulting material.

Thus, sample EC4 was then soaked in aqueous baths of various tanning materials (extracts of catechu, myrobalan, chestnut, potassium alum, and water alone) of increasing concentrations and then rinsed with water. The sample was then left for slow drying.

The water immersion tests showed that the sample obtained after drying has a good resistance to water (less decomposition compared to the sample EC4). Thus, the tanning process has fixed the structure of the plant proteins well.

Tanning also made the sample more resistant to mold (fungal growth is delayed compared to the sample EC4).

However, the sample obtained turned out to be very fragile (brittle). Its properties were in no way comparable to those of leather.

### 4. Mechanical Properties

Samples E15 to E116 and P1 to P2 were prepared in a Thermo Scientific™ brand Eurolab16 extruder, 16 mm in diameter and 640 mm in length, equipped with a 2 mm diameter snap ring die. The extruder has two intake zones, at least one conveying zone with compression, at least one kneading zone and a die zone.

The rotation speed of the twin-screws is 500 rpm and the temperatures of the different zones are between 40 and 160° C. The specific mechanical energies calculated are between 50 and 210 J/g.

Proteins, tannins and additives in solid form were introduced in the first intake zone.

The plasticizers and liquid additives were introduced in the second intake zone.

The screw profile is as follows: 22 mm kneading screw and 128 mm direct pitch screw.

Samples EI5 to EI16 and P1 to P2 were prepared by extrusion of the following mixtures (percentages are by mass to total mixture mass):

Samples EI5 to EI16 and P1 to P2 were prepared by extrusion of the following mixtures (percentages are by mass to total mixture mass):

| | EI5¹⁾ | EI6²⁾ | EI7³⁾ | EI8⁴⁾ | EI9⁵⁾ | P1⁶⁾ | P1⁷⁾ |
|---|---|---|---|---|---|---|---|
| Plant | Gluten | Gluten | Gluten | Gluten | Gluten | White | Broad Bean |
| Proteins | (59.5) | (57.1) | (54.6) | (52.4) | (50.2) | Chlorella | Proteins |
| (%) | | | | | | (51.8) | (51.8) |
| Plasticizer | Glycerol | Glycerol | Glycerol | Glycerol | Glycerol | Glycerol | Glycerol |
| (%) | (36.9) | (36.6) | (36.6) | (36.6) | (36.7) | (36.8) | (36.8) |
| | Potassium | Potassium | Potassium | Potassium | Potassium | Potassium | Potassium |
| | Sorbate | Sorbate | Sorbate | Sorbate | Sorbate | Sorbate | Sorbate |
| | (3.0) | (2.8) | (2.7) | (2.6) | (2.5) | (5.7) | (5.7) |
| Tanning | — | Gambier | Gambier | Gambier | Gambier | Gambier | Gambier |
| Agent (%) | | (2.9) | (5.5) | (7.9) | (10.1) | (5.2) | (5.2) |
| pH | Slaked | Slaked | Slaked | Slaked | Slaked | Slaked | Slaked |
| Modifier | Lime | Lime | Lime | Lime | Lime | Lime | Lime |
| (%) | (0.6) | (0.6) | (0.6) | (0.5) | (0.5) | (0.5) | (0.5) |

¹⁾Extrusion: 500 rpm, 140° C., 0 bar, 3.1N · m, EMS 129.2 J/g
²⁾Extrusion: 500 rpm, 140° C., 0 bar, 3.0N · m, EMS 125.1 J/g
³⁾Extrusion: 500 rpm, 140° C., 0 bar, 3.1N · m, EMS 129.2 J/g
⁴⁾Extrusion: 500 rpm, 140° C., 0 bar, 3.6N · m, EMS 150.1 J/g
⁵⁾Extrusion: 500 rpm, 140° C., 0 bar, 3.8N · m, EMS 158.4 J/g
⁶⁾Extrusion: 500 rpm, 140° C., 3 bar, 3.8N · m, EMS 158.4 J/g
⁷⁾Extrusion: 500 rpm, 140° C., 0 bar, 1.2N · m, EMS 50.0 J/g

| | EI10¹⁾ | EI11²⁾ | EI12³⁾ | EI13⁴⁾ | EI14⁵⁾ | EI15⁶⁾ |
|---|---|---|---|---|---|---|
| Plant | Gluten | Gluten | Gluten | Gluten | Gluten | Gluten |
| Proteins | (51.8) | (51.8) | (51.8) | (51.8) | (51.8) | (51.8) |
| (%) | | | | | | |
| Plasticizer | Glycerol | Glycerol | Glycerol | Glycerol | Glycerol | Glycerol |
| (%) | (36.8) | (36.8) | (36.8) | (36.8) | (36.8) | (36.8) |
| | Potassium | Potassium | Potassium | Potassium | Potassium | Potassium |
| | Sorbate | Sorbate | Sorbate | Sorbate | Sorbate | Sorbate |
| | (5.7) | (5.7) | (5.7) | (5.7) | (5.7) | (5.7) |
| Tanning | White | Buckthorn | Chestnut | Myrobalan | Reseda | Catechu |
| Agent (%) | Grape | (5.2) | (5.2) | (5.2) | (5.2) | (5.2) |
| | (5.2) | | | | | |
| pH | Slaked | Slaked | Slaked | Slaked | Slaked | Slaked |
| Modifier | Lime | Lime | Lime | Lime | Lime | Lime |
| (%) | (0.5) | (0.5) | (0.5) | (0.5) | (0.5) | (0.5) |

¹⁾Extrusion: 500 rpm, 140° C., 4 bar, 3.1N · m, EMS 129.2 J/g
²⁾Extrusion: 500 rpm, 140° C., 4 bar, 3.3N · m, EMS 137.6 J/g
³⁾Extrusion: 500 rpm, 140° C., 0 bar, 3.8N · m, EMS 158.4 J/g
⁴⁾Extrusion: 500 rpm, 140° C., 2 bar, 5.0N · m, EMS 208.5 J/g
^{5),6)}Extrusion: 500 rpm, 140° C., 3 bar, 3.3N · m, EMS 137.6 J/g

After extrusion, the rods of samples EI5 to EI9 and P1 to P2 were pressed as 2 mm thick plates at 130° C. and 60 bar for 15 minutes. Test specimens of type 1BA were cut, conditioned at 40° C. and 50% relative humidity and subjected to unidirectional tensile mechanical tests according to EN ISO527-2:2012 at a speed of 10 mm/min.

In order to compare their flexibility quantitatively, samples EI5 to EI9 were subjected to dynamic mechanical spectrometry (DMA) analysis in single embedding from −100 to 150° C. at a rate of 2° C./min, at a frequency of 1 Hz.

Glass transition temperatures were determined on the loss factor peak.

The samples were also subjected to mechanical tensile tests on a Shimadzu bench, performed at 10 mm/min, on an average of five test specimens.

The table below shows the characteristics of the EI5 to EI9 and P1 to P2 samples.

| | Strain at | Breakage | | Elastic | Elastic Modulus |
|---|---|---|---|---|---|
| | Break | Stress | Tg | Modulus at Tg | in Rubber Domain |
| | (%) | (MPa) | (° C.) | (MPa) | (MPa) |
| EI5 | 59.9% | 1.58 | 67 | 14 | 7 |
| EI6 | 52.7% | 1.50 | 66 | 12 | 5 |
| EI7 | 44.0% | 1.55 | 68 | 8 | 3 |
| EI8 | 52.7% | 1.64 | 71 | 5 | 2 |
| EI9 | 38.4% | 1.25 | 65 | 4 | 1 |
| P1 | 10.9% | 0.04 | — | — | — |
| P2 | 24.8% | 0.22 | — | — | — |

Samples EI5 to EI9 show a strain at break compatible with use in leather goods, despite a rather low strain at break, due to an absence of reinforcement filler in these samples.

It can be observed that when increasing amounts of a tanning agent are added, the mechanical properties of the samples in terms of tensile strength at room temperature are not drastically changed, but the glass transition temperatures and elastic moduli measured in DMA clearly evolve up to 7.9% tannin. This shows the ability of plant tanning agents to give flexibility to the material, without weakening it.

Samples P1 to P2 based on white chlorella and broad bean concentrate were also found to be thermoplastic and flexible, although they had lower mechanical strengths than the gluten-based blends.

Samples EI10 to EI15 were also subjected to mechanical tensile tests as above. In addition, they were compared to the specifications of the leather goods industry.

The frictional resistance was quantified by the Veslic test according to the standard ISO 11640:2018. The samples and rubbed felts were compared to a gray scale according to ISO 105 A02:1993 and ISO 105 A03:2019. The samples were also subjected to a flexural strength test according to ISO 5402-1:2017 and a surface extension and tensile strength test according to the ball method (ISO 3379:2015).

The table below shows the characteristics of the EI10 to EI15 samples.

| | | | | | Flexural | |
|---|---|---|---|---|---|---|
| | | | Veslic- | Veslic- | strength | Ball |
| | Strain | | Felts- | Sample- | (number of | method- |
| | at | Breakage | Dry | Dry | cycles | First |
| | Break | Stress | (250 | (250 | before | crack |
| | (%) | (MPa) | cycles) | cycles) | tearing) | (mm) |
| EI10 | 51.17% | 0.31 | 4/5 | 3/4 | 660 | 10 |
| EI11 | 57.02% | 0.39 | 4 | 3 | 1720 | 8.9 |
| EI12 | 50.37% | 0.24 | 4/5 | 4/5 | 5000 | 15.7 |
| EI13 | 43.48% | 0.22 | 4/5 | 3/4 | 1900 | 9.2 |
| EI14 | 44.22% | 0.37 | 4 | 2/3 | 2230 | 8.8 |
| EI15 | 70.98% | 0.47 | 4/5 | 4/5 | 320 | 9.4 |

By varying the botanical source of the plant tanning agents, it is possible to vary the strain at break from 43 to more than 70% and to multiply the strain at break by two. The frictional resistance is variable. Nevertheless, it is still possible to meet the standard specifications of leather goods. It is possible to achieve several thousand bending cycles without tearing the samples. All samples show a high resistance to ball penetration.

Samples EI10 to EI15 show the wide range of flexibility that can be achieved by varying the botanical source of the incorporated plant tannins.

### 5. Texturing

Samples T1 to T4 were prepared in a Thermo Scientific™ brand Eurolab16 extruder with a diameter of 16 mm and a length of 640 mm equipped with a flat film die having an adjustable gap thickness between 100 μm and 1 mm. The extruder has two intake zones, at least one conveying zone with compression, at least one kneading zone and a die zone.

The rotation speed of the twin-screws is 300 rpm and the temperatures of the different zones are between 40 and 200° C. The temperatures of the final extrusion zones and the flat film die are between 40 and 100° C.

Proteins, tannins and additives in solid form were introduced in the first intake zone.

The plasticizers and liquid additives were introduced in the second intake zone.

The screw profile is as follows: 22 mm kneading screw and 128 mm direct pitch screw.

Samples T1 to T4 were prepared by extrusion of the following mixtures (percentages are expressed in mass in relation to the total mass of the mixture):

| | T1¹⁾ | T2²⁾ | T3³⁾ | T4⁴⁾ |
|---|---|---|---|---|
| Plant Proteins (%) | Gluten (41.9) | Gluten (41.9) | Gluten (42.0) | Gluten (41.2) |
| Plasticizer (%) | Glycerol (40.6) | Glycerol (45.1) | Glycerol (42.1) | Glycerol (39.9) |
| | Potassium | Potassium | Potassium | Potassium |
| | Sorbate (4.6) | Sorbate (4.6) | Sorbate (7.1) | Sorbate (7.0) |
| | Water (4.5) | | | |
| Tanning Agent (%) | Gambier (4.6) | Gambier (4.6) | Gambier (7.1) | Gambier (7.0) |
| pH Modifier (%) | Slaked | Slaked | Slaked | Slaked |
| | lime (0.6) | lime (0.6) | lime (0.6) | lime (0.5) |
| Reinforcing | Kaolin (4.2) | Kaolin (4.2) | Corn Bran (4.2) | Corn Bran (4.1) |
| Filler (%) | | | | |
| Color additive (%) | — | — | — | Ferrous |
| | | | | Sulfate (3.7) |

¹⁾Extrusion: 300 rpm, 140° C., 5 bar, 4.0 N · m
²⁾Extrusion: 300 rpm, 140° C., 11 bar, 4.3 N · m
³⁾Extrusion: 300 rpm, 140° C., 8 bar, 3.6 N · m
⁴⁾Extrusion: 300 rpm, 140° C., 15 bar, 4.3 N · m

The appearance of the extrudate is observed. If the sheet obtained does not have a homogeneous texture, it is unsuitable for use.

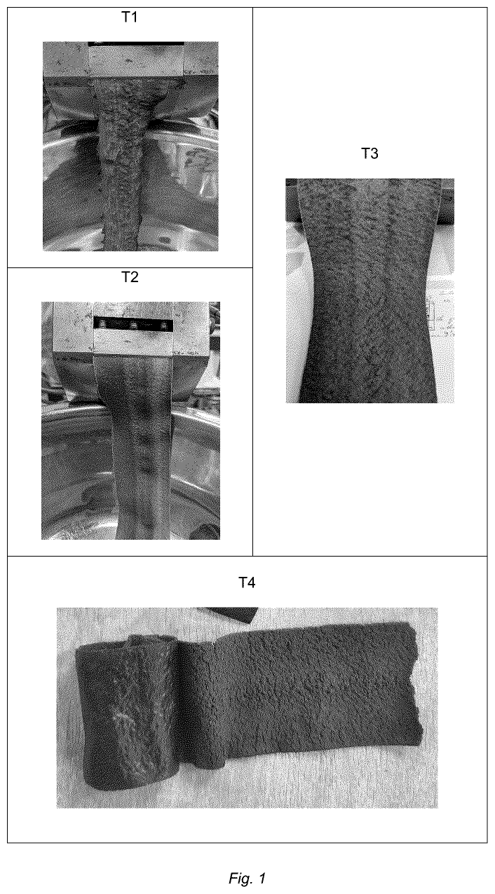

The results are shown in FIG. 1.

It is observed that the formula T1, which contains 4.5% additional water (additive water), shows significant structural defects: bubbles, holes and asymmetry of the sheet. It is therefore preferable not to add any additional water to the mixture.

For the other formulations, the fibrous textures are obtained uniformly and the sheets are soft. The sheets can be calendered between rolls with adjustable air gaps and heated or unheated. If only one of the rolls is heated, it is possible to obtain a fibrous aspect on one side and a smooth aspect on the other side (sample T4).

This double aspect is similar to leather, which has a grain side and a flesh side.

1. A method for preparing, from plant proteins, semi-finished products comprising the following steps:
(a) fluidizing and kneading a mixture comprising:
(i) plant proteins;
(ii) one or more plant tanning agents;
(iii) one or more plasticizers;
(b) compressing the fluidized and kneaded mixture in order to produce the semi-finished products.

2. The method according to claim 1, wherein the tanning agents are selected from polyphenolic tanning agents.

3. The method according to claim 1, wherein the proteins are plant proteins selected from the group consisting of cereal proteins, legume proteins, oilseed proteins, macro-algae proteins, microalgae proteins, and mixtures thereof.

4. The method according to claim 1, wherein the plasticizers are selected from the group consisting of water, crude glycerol, refined glycerol, glycerol derivatives, alcohols, polyols, saccharides and oligosaccharides, lignans, saturated or unsaturated carboxylic acids and their salts, coumarins, sulfonic acids, amino acids, urea, ionic liquids, eutectic solvents, and their mixtures.

5. The method according to claim 1, wherein the mixture further comprises organic or inorganic additives selected from the group consisting of fillers, dyes, pigments, viscosity modifiers, pH modifiers, preservatives, hydrophobic agents, surfactants, ionicity modifiers, UV stabilizers, and mixture thereof.

6. The method according to claim 1, wherein the fluidization is obtained by heating the mixture to a temperature ranging from 60° C. to 250° C.

7. The method according to claim 1, wherein the fluidization, the kneading, and the compression of the mixture are carried out in an extruder equipped with an extrusion head.

8. The method according to claim 1, wherein the semi-finished products are sheets, films, plates, wires, technical profiles, tubes, rods, or pellets.

9. The method according to claim 1, further comprising one or more of the following steps:
cooling the prepared semi-finished products;
drying the prepared semi-finished products;
granulating the prepared semi-finished products when the semi-finished products are technical profiles, tubes, or rods.

10. Semi-finished products obtainable by the method according to claim 1.

11. The semi-finished products according to claim 10, wherein the semi-finished products are sheets, films, plates, technical profiles, tubes, rods, or pellets.

12. A use of a semi-finished product according to claim 10 for preparing an article.

13. An article prepared from a semi-finished product according to claim 10.

14. The article according to claim 13, wherein the article is an injection molded article.

15. The method for preparing an article from a semi-finished product according to claim 10, comprising a step of shaping the semi-finished product under press, by extrusion calendering, extrusion swelling, extrusion spinning, injection, 3D printing, or molding.

16. The method according to claim 1, wherein the plant proteins are wheat gluten.

17. The method according to claim 1, wherein the plasticizers are selected from the group consisting of glycerol, urea, water, and mixtures thereof.

18. Semi-finished products obtainable by the method according to claim 9.
